(19) United States
(12) Patent Application Publication
(10) Pub. No.: US 2026/0203738 A1
(43) Pub. Date: Jul. 16, 2026

(54) Distributed Parking Management System with Adaptive Detection, Multi-Currency Payments, and Token-Based Enforcement

(71) Applicant: Joshua Mark Capps, Birmingham, AL (US)

(72) Inventor: Joshua Mark Capps, Birmingham, AL (US)

(73) Assignee: Nova X Quantum Inc., Birmingham, AL (US)

(21) Appl. No.: 19/446,929

(22) Filed: Jan. 12, 2026

Related U.S. Application Data
(60) Provisional application No. 63/744,649, filed on Jan. 13, 2025.

(51) Int. Cl. G06Q 20/14

(52) U.S. Cl. CPC G06Q 20/145; G06Q 2240/00

(57) ABSTRACT

A distributed and modular parking management system is disclosed that integrates adaptive vehicle detection, multi-currency payment processing, data-driven pricing optimization, tamper-resistant enforcement, dynamic connectivity, and renewable energy subsystems. Autonomous parking nodes utilize IoT sensors to detect vehicle occupancy and parking events in real time. A payment and settlement module supports transactions using fiat currency, cryptocurrencies, stablecoins, and other digitally represented monetary instruments with real-time conversion. A pricing engine dynamically adjusts parking fees based on demand, occupancy, and contextual inputs. Renewable energy subsystems provide sustainable operation using solar generation and energy storage. The system operates across multiple communication networks, including cellular, wireless local area, and satellite networks, enabling resilient deployment across diverse environments. The system improves the technical operation of parking infrastructure by enabling autonomous, sensor-verified detection, secure transaction processing, and resilient network operation across heterogeneous deployment environments.

### TECHNICAL FIELD

The present invention relates generally to parking and curbside infrastructure management systems, and more particularly to distributed, modular infrastructure platforms utilizing Internet-of-Things (IoT) sensors, multi-currency transaction processing, renewable and off-grid energy subsystems, secure and tamper-resistant data management, and data-driven optimization techniques.

The invention is applicable to urban, suburban, rural, and remote environments, including on-street parking, curbside zones, garages, surface lots, electric-vehicle charging locations, temporary or event-based parking areas, and off-grid or low-connectivity installations.

### BACKGROUND OF THE INVENTION

### Limitations of Existing Systems

Conventional parking systems suffer from numerous deficiencies, including:

### Limited Payment Flexibility

Most existing systems are restricted to single-currency or card-based payments and lack support for cryptocurrencies, stablecoins, and central bank digital currencies.

### Static Pricing Models

Fixed pricing fails to account for real-time occupancy, demand fluctuations, weather conditions, or special events.

### Inefficient Detection Technologies

Legacy detection mechanisms lack accuracy, scalability, redundancy, and tamper resistance.

### Connectivity Constraints

Many systems depend on a single network type and fail in low-bandwidth or remote locations.

### Energy Inefficiency

Parking infrastructure is typically grid-dependent and does not incorporate renewable energy generation or energy storage.

### Security Vulnerabilities

Existing systems lack robust tamper-resistant data storage, exposing violations and payments to manipulation.

Accordingly, there exists a need for a distributed, resilient, and technology-agnostic parking management system that addresses these deficiencies.

### SUMMARY OF THE INVENTION

The invention provides a distributed parking management platform composed of autonomous parking nodes, payment and settlement modules, pricing engines, renewable energy subsystems, and resilient connectivity frameworks.

The system enables:
Real-time detection of vehicle occupancy
Secure and flexible multi-currency payments
Data-driven dynamic pricing
Tamper-resistant enforcement records
Renewable and off-grid operation
Deployment across heterogeneous network environments

### BRIEF DESCRIPTION OF THE DRAWINGS

The accompanying drawings, which are incorporated herein and form a part of the specification, illustrate embodiments of the present invention and, together with the description, serve to explain the principles of the invention. Like reference numerals designate corresponding parts throughout the drawings.

FIG. 1 is a system-level architecture diagram illustrating a distributed parking management system comprising autonomous parking nodes with detection, pricing, payment, connectivity, and secure data management subsystems.

FIG. 2 illustrates a secure token-based enforcement and distributed ledger storage workflow for generating, signing, recording, and auditing parking violation records.

FIG. 3 illustrates a dynamic pricing engine workflow utilizing occupancy data and contextual inputs to determine parking fees.

FIG. 4 illustrates a multi-currency payment processing workflow supporting transactions using fiat currency, cryptocurrency, stablecoins, and central bank digital currencies.

FIG. 5 illustrates a renewable energy management subsystem for powering autonomous parking nodes using renewable energy sources and energy storage components.

FIG. 6 illustrates a multi-path connectivity framework enabling communication via cellular networks, wireless local area networks, and satellite networks.

FIG. 7 illustrates a tamper-resistant security workflow for protecting enforcement records and operational data using cryptographic techniques and secure storage.

FIG. 8 illustrates a violation detection and resolution workflow including evidence review, dispute handling, enforcement actions, and resolution recording.

FIG. 9 illustrates a digital-twin-based optimization system for simulating parking operations and generating optimized system outputs.

FIG. 10 illustrates a user interaction workflow supporting parking session management, payment initiation, transaction confirmation, and notification delivery.

FIG. 11 illustrates a full distributed system architecture showing coordination among autonomous parking nodes, pricing engines, payment and settlement modules, secure data management subsystems, renewable energy subsystems, and connectivity frameworks.

FIG. 12 illustrates a retrofit upgrade workflow for converting legacy parking infrastructure into a modern autonomous parking system using a retrofit adapter while reusing existing mounting structures and hard-wired power sources, and enabling auto-provisioning, network connectivity, and centralized management.

FIG. 13 illustrates a plug-and-play auto-provisioning workflow in which an autonomous parking node automatically registers, authenticates, receives configuration data, and becomes operational upon initial power-on without manual configuration.

FIG. 14 illustrates an offline store-and-forward synchronization workflow in which parking events and payment records generated by an autonomous parking node are cached locally during periods of network unavailability and automatically synchronized with remote systems upon restoration of connectivity.

### DETAILED DESCRIPTION OF THE INVENTION

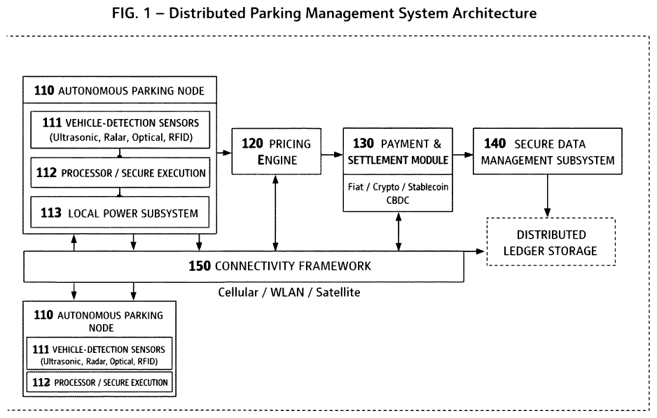

FIG. 1 illustrates a system-level architecture of a distributed parking management system 100 in accordance with one or more embodiments of the present invention. The distributed parking management system 100 comprises a plurality of autonomous parking nodes 110, each autonomous parking node 110 including one or more vehicle-detection sensors 111 configured to detect vehicle presence within a parking space, a processor and secure execution environment 112, and a local power subsystem 113. The autonomous parking nodes 110 are communicatively coupled via a connectivity framework 150 to a pricing engine 120, a payment and settlement module 130, and a secure data management subsystem 140.

In operation, the vehicle-detection sensors 111 generate occupancy data that is transmitted through the connectivity framework 150 to the pricing engine 120, which determines parking fees based on dynamic inputs including occupancy level, time, location, or demand. Pricing data is provided to the payment and settlement module 130, which processes usage-based infrastructure transactions using one or more currency types including fiat currency, cryptocurrency, stablecoins, and central bank digital currencies. Parking events and payment records are stored by the secure data management subsystem 140 in a tamper-resistant format. The plurality of autonomous parking nodes 110, the pricing engine 120, the payment and settlement module 130, and the secure data management subsystem 140 operate in coordination to detect vehicle occupancy in real time, calculate parking fees, process payments, and record parking events across a distributed parking infrastructure.

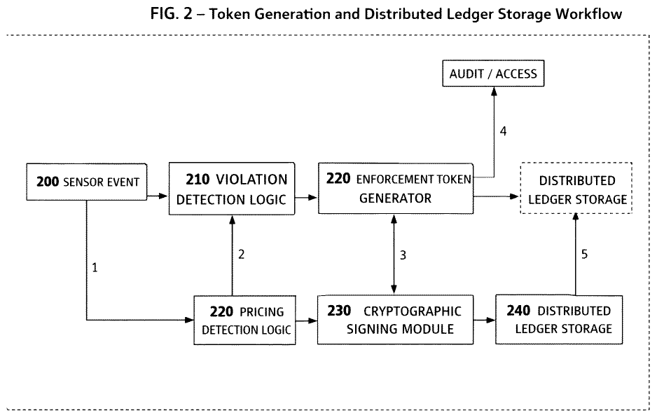

FIG. 2 illustrates a token generation and distributed ledger storage workflow 200 for parking violation enforcement in accordance with one or more embodiments of the present invention. A sensor event 200 is generated based on vehicle-detection data received from one or more vehicle-detection sensors associated with an autonomous parking node. The sensor event 200 is provided to violation detection logic 210, which evaluates the sensor event against one or more authorized parking conditions to determine whether a parking violation has occurred.

Upon confirmation of a parking violation, the violation detection logic 210 initiates creation of an enforcement token using an enforcement token generator 220. In some embodiments, the enforcement token generator 220 may receive contextual or pricing-related information from pricing or authorization logic 225. The enforcement token is provided to a cryptographic signing module 230, which cryptographically signs the enforcement token to produce a tamper-resistant enforcement record.

The signed enforcement token is transmitted to distributed ledger storage 240, where it is immutably recorded. In some embodiments, the distributed ledger storage 240 enables verification or auditing via an audit or access interface 250 without modification of the underlying enforcement token. The workflow of FIG. 2 provides a secure, sensor-verified, and tamper-resistant enforcement mechanism.

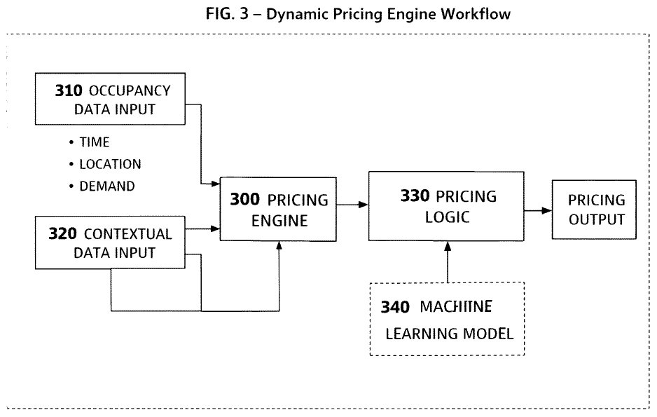

FIG. 3 illustrates a dynamic pricing engine workflow 300. The pricing engine 300 receives occupancy data 310 and contextual data 320, including time, location, or demand-related information. Pricing logic 330 processes the received data to calculate one or more parking fees. In some embodiments, pricing logic 330 may utilize one or more machine-learning models 340 trained on historical occupancy or demand data. The calculated pricing output is provided for use by downstream payment or settlement components.

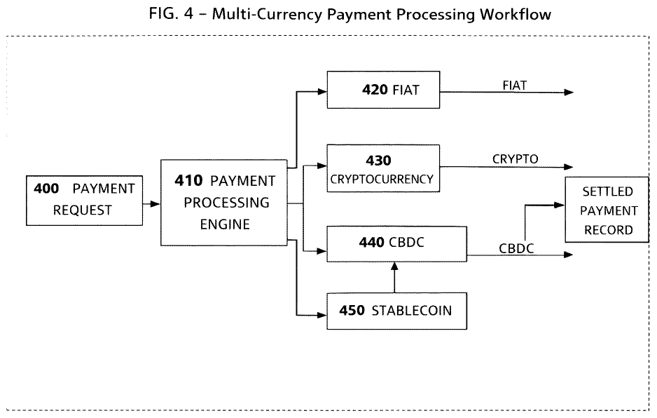

FIG. 4 illustrates a multi-currency payment processing workflow 400. A payment request 410 is initiated in response to a parking event and provided to a payment and settlement module 420. The payment and settlement module 420 supports transactions using fiat currency, cryptocurrency, stablecoins, and central bank digital currencies. In some embodiments, currency conversion logic 430 is invoked prior to settlement. Upon successful processing, a payment confirmation 440 is generated and recorded by a secure data management subsystem.

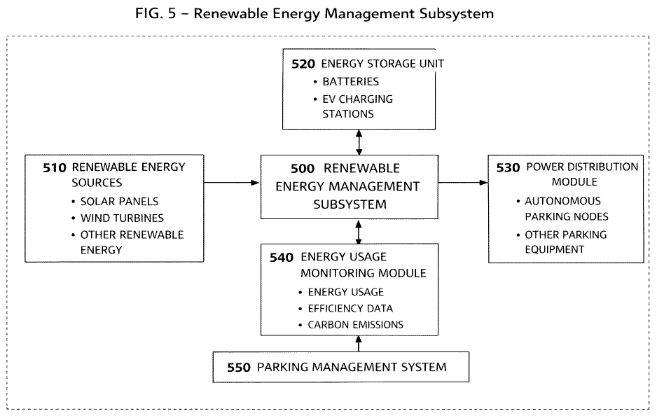

FIG. 5 illustrates a renewable energy management subsystem 500. The subsystem 500 receives energy from renewable energy sources 510, including solar or wind generation. Energy is stored in an energy storage unit 520. Energy is distributed via a power distribution module 530 to one or more autonomous parking nodes. An energy usage monitoring module 540 tracks consumption and operational metrics, enabling coordinated optimization via a parking management system 550.

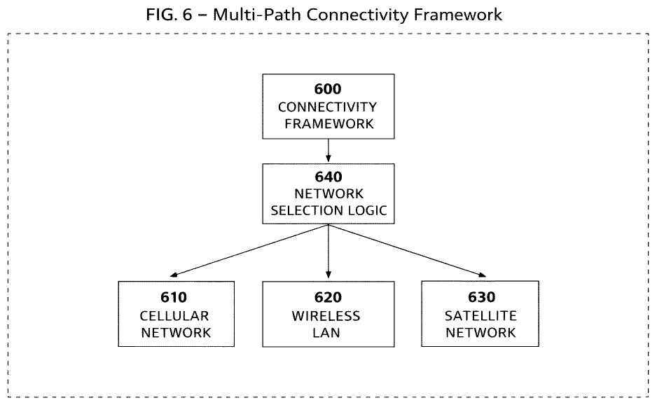

FIG. 6 illustrates a multi-path connectivity framework 600. The connectivity framework 600 manages communication between autonomous parking nodes and remote system components. Network selection logic 640 evaluates parameters such as latency, bandwidth, reliability, and availability. Available network types include cellular networks 610, wireless local area networks 620, and satellite networks 630. The connectivity framework 600 enables automatic network switching or redundant communication paths to ensure resilient system operation.

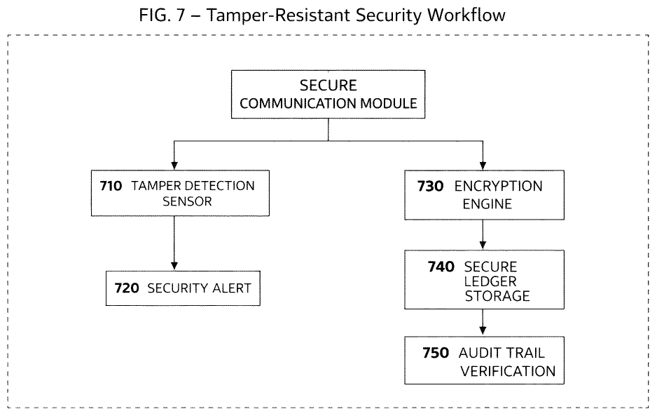

FIG. 7 illustrates a tamper-resistant enforcement security workflow. A sensor event 700 is evaluated by violation detection logic 710. Upon violation detection, an enforcement token generator 720 creates a digital enforcement token. The token is cryptographically secured by a signing module 730 and recorded in a distributed ledger storage subsystem 740. Authorized access is provided via an audit interface 750.

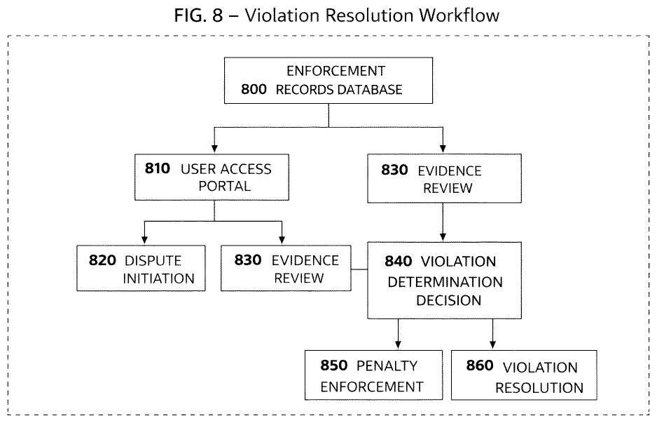

FIG. 8 illustrates a violation detection and resolution workflow. Sensor data collected by autonomous parking nodes 800 is evaluated by a violation detection module 810. Upon detection, a resolution decision module 820 determines enforcement actions. User notifications may be delivered via a notification interface 830, and final outcomes are recorded by a resolution outcome module 840 in a secure data store.

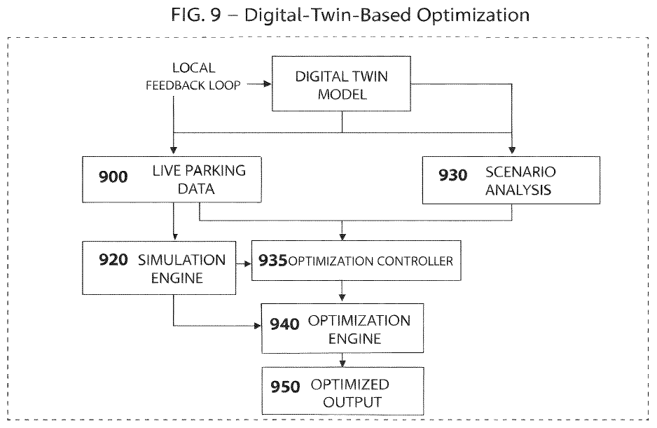

FIG. 9 illustrates a digital-twin-based optimization system. Live parking data 900 is provided to a digital twin model and a simulation engine 920. Scenario analysis 930 and optimization control 935 generate optimized outputs 950, which may be applied to system operations.

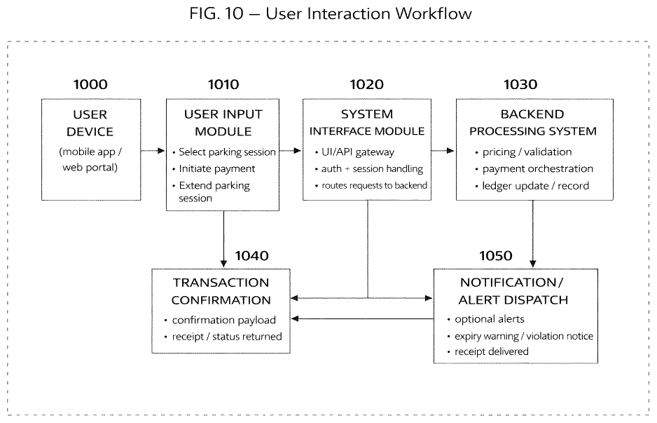

FIG. 10 illustrates a user interaction workflow. A user device 1000 communicates with a user input module 1010, system interface module 1020, backend processing system 1030, transaction confirmation module 1040, and notification dispatch module 1050.

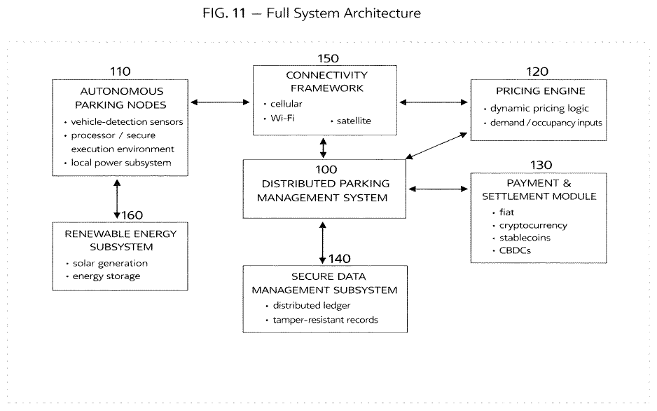

FIG. 11 illustrates a full system architecture of the distributed parking management system 100. Autonomous parking nodes 110 communicate via a connectivity framework 150. A pricing engine 120, payment and settlement module 130, secure data management subsystem 140, and renewable energy subsystem 160 operate in coordination.

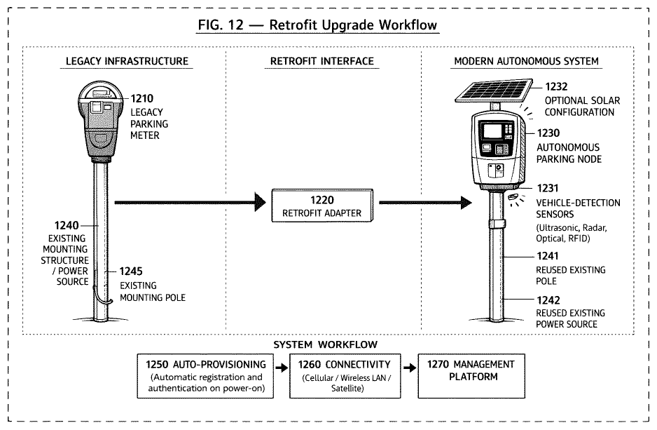

FIG. 12 illustrates a retrofit upgrade workflow 1200 for converting legacy parking infrastructure into a modern autonomous parking system. The workflow includes legacy infrastructure, a retrofit interface, and a modern autonomous system, followed by auto-provisioning 1250, connectivity 1260, and a management platform 1270.

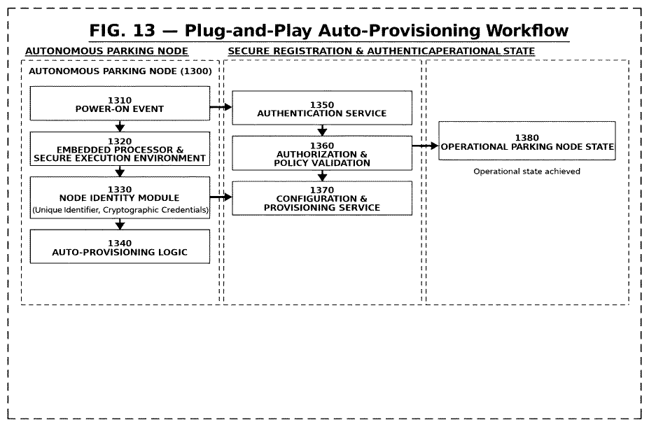

FIG. 13 illustrates a plug-and-play auto-provisioning workflow. An autonomous parking node 1300 initiates the workflow upon a power-on event 1310. Auto-provisioning logic 1340 performs secure registration and authentication via an authentication service 1350. Configuration and provisioning data are delivered, and the node transitions to an operational state 1380.

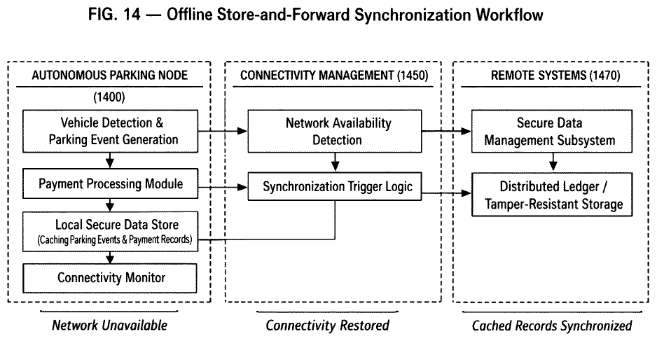

FIG. 14 illustrates an offline store-and-forward synchronization workflow. An autonomous parking node 1400 caches parking events and payment records in a local secure data store 1430 during network unavailability. Upon restoration of connectivity, synchronization logic transmits cached records to remote systems 1470 and a secure data management subsystem 1475 for recording in tamper-resistant storage 1480.

### INDUSTRIAL APPLICABILITY

The invention is applicable to municipal parking, private parking operators, smart-city infrastructure, and remote or off-grid deployments.

1. A distributed parking management system, comprising:
a plurality of autonomous parking nodes each physically associated with a respective parking space, each autonomous parking node comprising:
one or more vehicle-detection sensors configured to generate real-time occupancy data;
a processor executing stored instructions within a secure execution environment;
a local power subsystem; and
a communication interface;
a pricing engine operatively coupled to the plurality of autonomous parking nodes and configured to:
receive the real-time occupancy data;
automatically recalculate a parking fee in response to detected changes in occupancy conditions without human intervention; and
transmit updated pricing data to at least one autonomous parking node;
a payment and settlement module configured to:
initiate and settle usage-based parking transactions in response to the recalculated parking fee;
support settlement using multiple currency types including fiat currency, cryptocurrency, stablecoins, and central bank digital currencies; and
generate a cryptographically verifiable transaction record;
an enforcement subsystem configured to:
automatically evaluate whether a parking violation condition has occurred based on the real-time occupancy data and the recalculated parking fee; and
generate a cryptographically signed enforcement token only upon confirmation of the violation condition; and
a secure data management subsystem configured to immutably store the transaction record and the enforcement token in a tamper-resistant data structure;
wherein detection of vehicle occupancy automatically triggers dynamic pricing recalculation, conditional transaction processing, and enforcement token generation in a closed-loop autonomous workflow executed without manual intervention.

2. A computer-implemented method for autonomous parking infrastructure management, comprising:
detecting vehicle occupancy using one or more sensors physically associated with a parking space;
generating real-time occupancy data;
automatically recalculating a parking fee based on the real-time occupancy data;
initiating a parking transaction without manual pricing input;
settling the parking transaction using at least one selected from fiat currency, cryptocurrency, stablecoins, or central bank digital currencies;
determining whether a parking violation condition exists based on sensor-verified occupancy exceeding an authorized condition; and
upon confirmation of the parking violation condition, generating and immutably recording a cryptographically signed enforcement token;
wherein recalculation of the parking fee and generation of the enforcement token are automatically triggered by changes in sensor-detected occupancy conditions.

3. A distributed infrastructure platform, comprising:
a plurality of autonomous infrastructure nodes deployable across heterogeneous physical environments, each node comprising:
detection sensors;
a processor executing authorization and pricing logic;
a communication interface supporting multiple network types; and
a local or renewable power subsystem;
centralized or distributed control logic configured to coordinate dynamic pricing, authorization enforcement, and transaction settlement across the plurality of autonomous infrastructure nodes; and
a synchronization subsystem configured to:
locally cache operational data during network unavailability; and
synchronize the cached operational data upon restoration of connectivity using ordered synchronization logic preventing duplication or omission of records;
wherein the platform maintains continuous autonomous operation during intermittent connectivity conditions.

4. The system of claim 1, wherein the vehicle-detection sensors comprise ultrasonic, radar, optical, RFID, or multi-modal redundant sensors.

5. The system of claim 1, wherein the secure execution environment prevents unauthorized modification of pricing or enforcement logic.

6. The system of claim 1, wherein the secure data management subsystem comprises a distributed ledger.

7. The system of claim 6, wherein the distributed ledger prevents modification or deletion of enforcement tokens once recorded.

8. The system of claim 1, wherein the pricing engine utilizes predictive analytics trained on historical occupancy patterns.

9. The system of claim 8, wherein predictive outputs modify parking availability allocation prior to occupancy threshold breaches.

10. The system of claim 1, wherein the communication interface automatically switches between cellular, wireless local area, and satellite networks based on latency or signal quality.

11. The system of claim 1, wherein the local power subsystem comprises solar generation and battery storage enabling grid-independent operation.

12. The system of claim 1, wherein the enforcement token includes at least a timestamp, parking space identifier, and cryptographic signature.

13. The system of claim 1, wherein enforcement token generation requires confirmation from redundant sensors.

14. The method of claim 2, wherein settlement includes real-time currency conversion prior to transaction completion.

15. The method of claim 2, wherein transaction settlement is initiated via machine-to-machine communication without user interaction.

16. The platform of claim 3, wherein synchronization uses cryptographic hashing prior to transmission.

17. The platform of claim 3, wherein cached operational data is encrypted prior to synchronization.

18. The platform of claim 3, wherein synchronization prioritization is based on bandwidth availability or operational priority.

19. The system of claim 1, wherein an autonomous parking node is configured to retrofit an existing parking meter using a pre-existing mounting structure and power source.

20. The system of claim 1, wherein the autonomous parking node automatically registers and becomes operational upon initial power-on.

21. The system of claim 1, wherein recalculated pricing is transmitted to user devices in real time.

22. The system of claim 1, wherein transaction records and enforcement tokens are auditable by an external verification interface without modification of stored data.

23. The system of claim 1, wherein enforcement logic is executed within a tamper-resistant secure hardware module.
